(19) United States
(12) Patent Application Publication
(10) Pub. No.: US 2007/0083558 A1
(43) Pub. Date: Apr. 12, 2007

(54) Media item registry and associated methods of registering a rights holder and a media item

(75) Inventor: Ronald Martinez, San Francisco, CA (US)

Correspondence Address: GREENBERG TRAURIG, LLP, MET LIFE BUILDING, 200 PARK AVENUE, NEW YORK, NY, 10166, US

(73) Assignee: YAHOO! INC., Sunnyvale, CA (US)

(21) Appl. No.: 11/453,476

(22) Filed: Jun. 14, 2006

Related U.S. Application Data
(63) Continuation-in-part of application No. 11/247,015, filed on Oct. 10, 2005.
(63) Continuation-in-part of application No. 11/292,034, filed on Nov. 30, 2005.

(51) Int. Cl. G06F 17/00

(52) U.S. Cl. 707/104.1

(57) ABSTRACT

A media item registry associated with media items, whether media item portions or composite media items portions and their associated rights holders. In one embodiment, a method of registering a rights holder. In another embodiment, a method of registering a media items. In one embodiment, the media item registry enables the appropriate payment to each rights holder associated with a media item through a media item payment system. In another embodiment, the present disclosure relates to a method for handling discrepancies among media items, rights holders, and their associated ids.

### CROSS-REFERENCE TO RELATED APPLICATION

This application claims the benefit of and is a continuation-in-part of U.S. application Ser. No. 11/247,015 filed Oct. 10, 2005, entitled A DATA CONTAINER AND SET OF METADATA FOR ASSOCIATION WITH A MEDIA ITEM AND COMPOSITE MEDIA ITEMS, which is hereby incorporated herein by reference; and this application claims the benefit of and is a continuation-in-part of U.S. application Ser. No. 11/292,034, filed Nov. 30, 2005, entitled A USER INTERFACE FOR A MEDIA ITEM PORTION SEARCH TOOL, which is also hereby incorporated herein by reference.

### TECHNICAL FIELD

The present disclosure relates generally to a media item registry associated with media items, whether media item portions or composite media items portions and their associated rights holders. In one embodiment, the present disclosure relates to a method of registering a rights holder. In another embodiment, the present disclosure relates to a method of registering a media items. In a further embodiment, the media item registry enables the appropriate payment to each rights holder associated with a media item through a media item payment system. In another embodiment, the present disclosure relates to a method for handling discrepancies among media items, rights holders, and their associated ids.

Further, the present disclosure relates generally to a media item payment system for calculating payments when a media item is used and/or purchased. In one embodiment, the media item payment system is used in conjunction with and/or is in communication with the media item registry. In another embodiment, the media item payment system functions independently from the media item registry.

### BACKGROUND

The practice of mixing and remixing media is no longer restricted to media professionals. Emerging technology of remixing digital media enables end-users to combine media items and media item portions into new, composite media items. However, there lacks a system or registry in which providers of media items and media item portions available for remixing on a commercial or any other basis may readily publish the necessary metadata to support such use or distribution of their media, and specifically to enable payment from multiple participants in what is ideally a highly distributed, decentralized marketplace. Further, there lacks a system or accessible registry where media items are correctly associated with their actual owners or rights holders, such that these rights holders may be properly compensated. Also, current systems lack a generalized, reliable, or distributed method and system available to ensure that rights holders of such media portions are compensated for their work.

### SUMMARY

The present disclosure addresses these deficiencies in the current art. In one embodiment, the present disclosure provides for a media item registry. In one embodiment, rights holders are capable of registering themselves in the media item registry. In another embodiment, a rights holder is able to register a media item in the registry. In another embodiment, either one or both of the rights holder and media item are associated with an id. In a further embodiment, the registry is capable, via a media item payment system, of compensating the appropriate rights holder upon a use or transaction associated with the rights holder's associated media item.

Further, the present disclosure provides for a media item payment system for calculating payments when a media item (whether it is a composite media item and/or media item portion) is purchased and/or used. Further, the media item payment system can render the payments to the appropriate rights holder. The media item payment system can function independently from the media item registry or in conjunction with the media item registry.

In one embodiment, a method of registering a rights holder in a media item registry is disclosed. In one embodiment, the method comprises receiving, at an online media item registry, account information associated with a rights holder, the rights holder associated with rights in a media item, the media item being available to create a composite media item; and generating a unique id associated with the rights holder, the id being associated with the media item so that as the media item is used in commerce the unique id remains linked to the media item to thereby enable the media item to be utilized in accordance with requirements established by the rights holder.

In one embodiment, the media item comprises a media item portion.

In one embodiment, media item comprises a data container format.

In one embodiment, the step of associating the unique id with the media item comprises incorporating the unique id into the data container format.

In one embodiment, the account information comprises an identity of the rights holder, an address associated with the rights holder, contact information associated with the rights holder, a user-defined login, and/or a user-defined password.

In one embodiment, the method further comprises receiving remittance information associated with the rights holder.

In one embodiment, the remittance information comprises bank account information associated with the rights holder, facilitates a payment to the registry, the payment comprising a fee associated with maintaining the registry, facilitates a payment to the rights holder, the payment comprising a fee associated with use of the media item.

In one embodiment, the id comprises an alphanumeric string of characters.

In one embodiment, the incorporated id is searchable on the internet.

In one embodiment, the rights holder is an entity.

In one embodiment, the id is required in order to use the media item in a derivative work.

In one embodiment, the method further comprises authenticating the rights holder id.

In one embodiment, a method of registering a media item with an online media item registry is disclosed. In one embodiment, the method comprises receiving, at an online media item registry, a set of metadata associated with a media item, the media item being available to create a composite media item; generating a media item id associated with the media item and the set of metadata, the media item id being associated with the media item; and storing at least the generated id so that the media item and the set of metadata are available to a searching entity.

In one embodiment, the media item comprises a media item portion.

In one embodiment, the media item comprises a data container format.

In one embodiment, the step of associating the media item id with the media item comprises incorporating the media item id into the data container format.

In one embodiment, the media item id is associated with a first rights holder id associated with a first rights holder, the first rights holder associated with the media item.

In one embodiment, the first rights holder id must be authenticated before the first In one embodiment, the method further comprises replacing the first rights holder id with a second rights holder id associated with a second rights holder if ownership of the media item is transferred from the first rights holder to the second rights holder.

In one embodiment, the method further comprises sending, if the media item id is requested, the metadata set to a requesting entity.

In one embodiment, the requesting entity must be authenticated before the metadata set can be sent to the requesting entity.

In one embodiment, the method further comprises sending, if the media item id is requested, the media item to a requesting entity.

In one embodiment, the requesting entity must be authenticated before the media item can be sent to the requesting entity.

In one embodiment, the metadata set comprises commerce enabling information associated with the media item, a pointer associated with the media item, an uniform resource locator associated with the media item, a title associated with the media item, an artist name associated with the media item, an identity of a creator associated with the media item, content of the media item, and/or a length of the media item.

In one embodiment, the media item id comprises an alphanumeric string of characters, and/or the media item id is searchable on the internet.

In one embodiment, the set of metadata is not stored in the media item registry if the set of metadata is already associated with a media item id.

In one embodiment, a method of reporting discrepancies associated with a media item is disclosed. In one embodiment, the method comprises receiving, at an online media item registry, a user-defined discrepancy report, the report comprising information associated with a discrepancy associated with a media item, the media item associated with a media item id; transferring the discrepancy report to a dispute resolution process; and notifying a rights holder associated with the media item.

In one embodiment, the media item comprises a media item portion.

In one embodiment, the discrepancy comprises an incorrect rights holder associated with the media item, and/or an incorrect set of metadata associated with the media item.

In one embodiment, the method further comprises notifying the incorrect rights holder of the discrepancy.

In one embodiment, a payment associated with use of the media item is suspended upon receipt of the discrepancy.

In one embodiment, the method further comprises removing the media item from the registry until the discrepancy is resolved.

In one embodiment, a method of registering a rights holder in a media item registry is disclosed. In one embodiment, the method comprises receiving, at an online media item registry, account information associated with a rights holder, the rights holder associated with rights in a media item, the media item being available to create a composite media item; and generating a unique id associated with the rights holder, the id being associated with the media item so that as the media item is used in commerce the unique id remains linked to the media item to thereby enable the rights holder to be appropriately compensated for the use of the media item.

In one embodiment, the media item comprises a media item portion.

In one embodiment, n the use comprises combining the media item with another media item so as to create a composite media item.

In one embodiment, the use comprises a purchase of the media item.

In one embodiment, the media item comprises a data container format.

In one embodiment, associating the unique id with the media item comprises incorporating the unique id into the data container format.

In one embodiment, the account information comprises an identity of the rights holder.

In one embodiment, the method further comprises receiving remittance information associated with the rights holder.

In one embodiment, the remittance information comprises bank account information associated with the rights holder.

In one embodiment, the remittance information facilitates a payment to the rights holder, the payment comprising a fee associated with the use of the media item.

### BRIEF DESCRIPTION OF THE DRAWINGS

The following drawing figures, which form a part of this application, are illustrative of embodiments of the present disclosure and are not meant to limit the scope of the disclosure in any manner, which scope shall be based on the claims appended hereto.

FIG. 1 is an exemplary flowchart according to an embodiment of the present disclosure;

FIG. 2 is an exemplary flowchart according to an embodiment of the present disclosure;

FIG. 3 is an exemplary flowchart according to an embodiment of the present disclosure; and

FIG. 4 is an exemplary system configuration in accordance with an embodiment of the present disclosure;

FIG. 5 is a exemplary system configuration in accordance with an embodiment of the present disclosure.

FIG. 6 is an exemplary figure according to an embodiment of the present disclosure;

FIG. 7 is an exemplary figure according to an embodiment of the present disclosure;

FIG. 8 is an exemplary figure according to an embodiment of the present disclosure;

FIG. 9 is an exemplary figure according to an embodiment of the present disclosure;

FIG. 10 is an exemplary figure according to an embodiment of the present disclosure; and

FIG. 11 is an exemplary figure according to an embodiment of the present disclosure.

### DETAILED DESCRIPTION OF EMBODIMENTS

In one embodiment, the present disclosure relates generally to a media item registry. In one embodiment, rights holders are capable of registering themselves. In another embodiment, a rights holder is able to register a media item in the registry. In another embodiment, either one or both of the rights holder and media item are associated with an id. In a further embodiment, the registry is capable of compensating the appropriate rights holder upon a use or transaction associated with the rights holder's associated media item.

In one embodiment, the media item registry comprises a database. Further, the term “database” as used herein can mean any collection of entries which may be accessible and/or searchable. In one aspect, a database comprises an organized body of information. In one aspect, a database comprises a systematically arranged collection of computer data, structured so that it can be retrieved or manipulated. Further, the database may be a single database or a distributed database located anywhere such as the internet, a network, on a local area network, wireless area network, on a computing device, or any type of suitable infrastructure.

In one embodiment, the media item registry comprises a server. Further, the term “server” as used herein can mean a computing device in a network that stores application programs and data files accessed by other computing devices. In one embodiment, a computing device may comprise a personal computer, a cellular phone, a personal digital assistant, or any other type of portable computing device capable of communicating with the media item registry.

In one embodiment, the term “media item” as used herein can mean any type of media. Also, in one embodiment, the term media item as used herein encompasses the terms media item portions and composite media items. Thus, as used herein, the terms “content”, “media”, or “media items” are used broadly to encompass any type or category of experienceable, retrievable, filed and/or stored media, either singly or collectively, and individual items of media or content are generally referred to as entries, songs, tracks, items or files, however, the use of any one term is not to be considered limiting as the concepts features and functions described herein are generally intended to apply to any storable and/or retrievable item that may be experienced by a user, whether audibly, visually or otherwise, in any manner now known or to become known. Further, the term media comprises all types of media such as audio and video, text, photos, or other forms.

Accordingly, in some embodiments, the term “media item portion” may be any type of identifiable portion or component of media item. Thus, in one embodiment, a media item portion is a subset or type of a media item. For example, a media item portion may comprise an a capella track, a backing track, a sample or loop of a media item recording, the beat of a media item, the chords of a media item, a graphical still image, a portion of a video file or other type of dynamic image, the equalizer presets, a band or orchestra accompaniment, the instrumentals, a portion of a podcast, a conductor or performer refinement, or part of a set, or any other identifiable portion of a media item. Further, a media item portion may comprise two or more media item portions.

Further, the term “composite media item” as used herein can mean a type of media created from two or more media item portions. Thus, a composite media item is a type of a media item. In a further embodiment, the composite media item comprises portions of media items and sets of metadata thus, it is contemplated that in one embodiment, a media item portion can be considered a composite media item as it may comprise two or more media item portions.

In one embodiment, a data container is associated with a media item and/or a media item portion. In this embodiment, a container is a structure that allows items and or other containers to be grouped. In another embodiment, a container can also comprise sets of metadata which may or may not be physically located in the container. Thus in one embodiment, the data container comprises any number and type of set(s) of metadata associated with a media item portion (whether a media item portion, media item, or composite media item), any number and type of set(s)of metadata associated with the container itself and any number and type of media item identifier(s). In one exemplary embodiment, the metadata comprises information or data about a media item such as the name of the artist or performer, the album name, the identity of a composer, the identity of lyricist, the identity of a lead performer or soloist, the genre, the tempo, the rhythm pattern, the date or time of recording of the media item, identity of the language associated with the media item, the original filename of the media item, the original release year of the media item, the format type of the media item, a URL or link to the official webpage of an on-demand music service or internet radio station, or the a URL or link to the official webpage of the artist, album, rights holder, or producer associated with the media item. In a further embodiment, the metadata comprises a set of commerce enabling information. In another embodiment, the metadata comprises a name or descriptive term, a pointer to commerce enabling information, a pointer to the location of the associated media item, at least one set of informative tags associated with the media item, the format type associated with the media item, and/or an ID unique to an online music service.

Certain embodiments of the present disclosure will now be discussed with reference to the aforementioned figures wherein like reference numerals refer to like components. The figures are intended as exemplary embodiments and are not intended to be limiting.

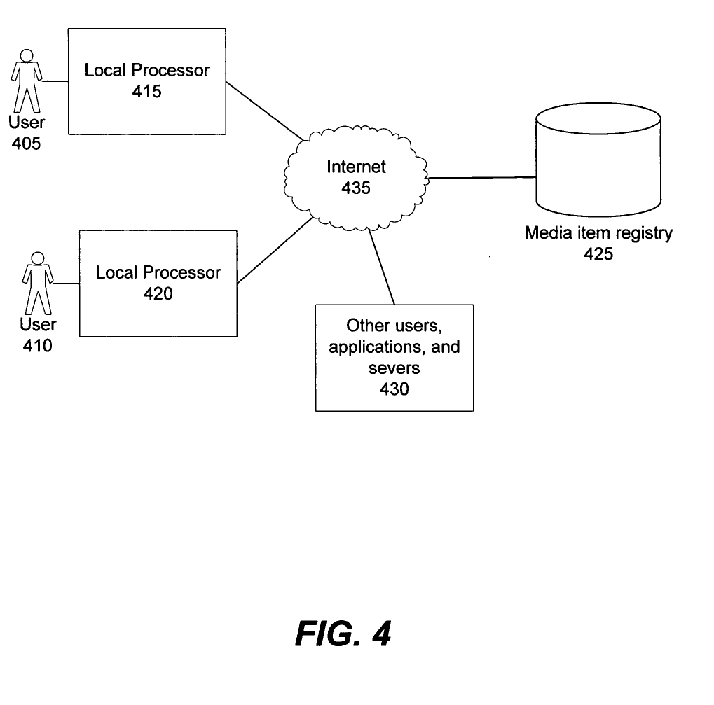

The present disclosure is generally related to a media item registry capable of registering media item and its associated metadata, registering rights holders, issuing appropriate payment or compensation to the rights holders, and/or handling discrepancies within the registry. An exemplary system architecture or configuration is depicted in FIG. 4. As can be seen in FIG. 4, the system comprises of one or more users 405 and 410 at a local processor 415 and 420 respectively, a media item registry 425, other users, applications, or servers 430, each connected to the internet 435. In one embodiment, the media item registry 425 is a database available online. As can be seen in FIG. 4, each user 405, 410, and any other users, applications, or servers 430 may access and communicate with the media item registry 435.

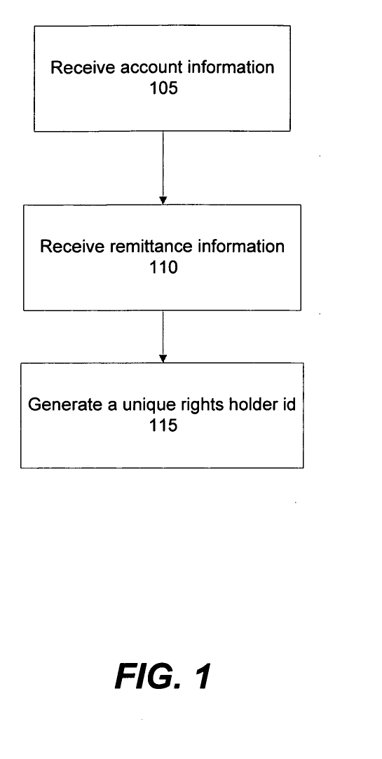

One exemplary method of registering a rights holder at a media item registry is depicted in FIG. 1. As shown in FIG. 1, the media item registry receives account information associated with a rights holder 105. In one embodiment, when registering a rights holder, the account information is populated by the rights holder. In one embodiment, the rights holder populates the account information via a web-based user interface. Such account information may comprise information necessary to create an online account associated with a rights holder. For example, account information may comprise a login and password which may or may not be user-defined. In another embodiment, account information may comprise contact information for the rights holder. Further account information may comprise the name, identity, a self-defined handle, an alias associated with a rights holder, or any other information for identifying a rights holder.

In one embodiment, the media item registry receives remittance information 110. In one embodiment, remittance information comprises bank account and routing information for facilitating electronic transfers. In further embodiments, remittance information may comprise information indicating an address for remittance where a physical check is a preferred form of payment. In another embodiment, remittance information may comprise indicating a payment method, such as a credit card, to support registration fees or any other fees associated with supporting the media item registry. In one embodiment, the remittance information allows the media item registry to determine who or what rights holder or associated bank or account to issue payment to when one of that rights holder's associated media items have been used in a relevant transaction requiring payment.

After either one or both of the account information and/or remittance information is received, the media item registry generates 120 a unique id associated with the rights holder. In one embodiment, the rights holder id comprises an alphanumeric string of characters. In another embodiment, the rights holder comprises the name of the rights holder. In one embodiment, the rights holder may be any type of entity such as an individual, corporation, record label, media company, and/or association. In one embodiment, the rights holder id is associated with the rights holders in such a way that a rights holder can also associate their media items with their rights holder id.

In one embodiment, the media item comprises a data container structure. Accordingly, the right holder id is incorporated into the data container or otherwise associated with the data container and thus associated with the media item . In further embodiments, a rights holder id is associated with their media item by bounding the rights holder id to the metadata associated with the media item.

In one embodiment, associating the rights holder id with the media item allows the media items to be easily searchable and organized by a rights holder id. Further, the rights holder id can be found from each media item so that the identity of the rights holder is easily known. In another embodiment, the media item and the rights holder id may be found directly by browsers, players, remix software tools, media item payment systems, or by commerce systems underlying remix media marketplaces. For example, in one embodiment, a media item payment system as described in greater detail herein, is capable of identifying a media item via its associated rights holder id in order to calculate the proper payment for its use.

Of course, it is contemplated that at any time a rights holder can update their account information and/or remittance information. In one embodiment, such an update would be required when the media items owned or associated with a rights holder are acquired by a different rights holder. For example, in a merger, sale, acquisition, or other scenarios where media items associated with a registered right holders are transferred to another rights holder. In such scenarios, in one embodiment, an aliasing process may occur. In one embodiment, the aliasing process requires both rights holders to authenticate to the media item registry to authorize the association of their rights holder ids. For example, if a first right holder id (ABC123) is associated with media portion X, but media portion X is acquired by a second right holder id (DEF456), after an aliasing processing, then media portion X will be associated with only the second rights holder id (DEF456).

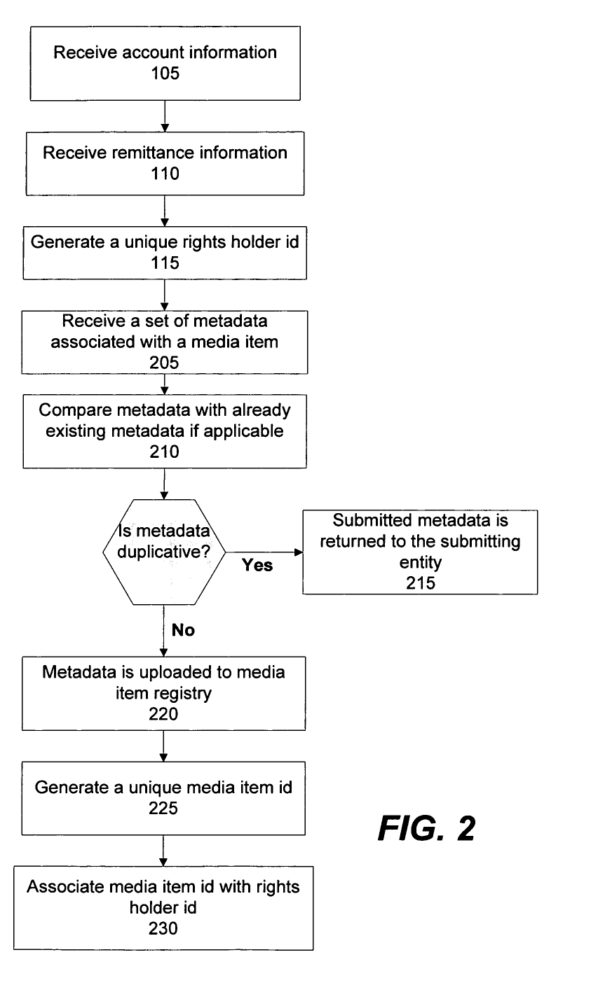

The present disclosure is also generally related to a method of registering a media item, whether a composite media item or media item portion. Thus, in one embodiment, the rights holder can both register himself and/or register their associated media items at the media item registry. One exemplary method of registering a media item is depicted in FIG. 2. As can be seen in FIG. 2, in one embodiment, similar to the method depicted in FIG. 1, account information is received 105, remittance information may be received 110 and a rights holder id is generated 115. Then, the media item registry receives 205 metadata associated with a media item. In another embodiment, if a rights holder is already registered with the media item registry, steps 105-115 are not necessary. Instead, the rights holder can register a media item via steps 205-225 as described in further detail herein.

In one embodiment, the metadata associated with a media item may be uploaded by the rights holder. In one embodiment, such metadata may comprise media type, artist, title of the media item, length, or any type of commerce enabling information. In one embodiment, “commerce enabling” information governs the use of a media item. Commerce enabling information refers, by way of non-limiting example, to information, data, or pointers thereto, that can be utilized to facilitate electronic commerce involving a media item. For example, such commerce enabling information can comprise the identity of attribution, the identity of a rights holder, a link or address of a website, a copyright message or a pointer thereto, licensing information or pointer thereto, or a digital rights management (DRM) related license or authorization or pointer thereto. The commerce enabling information may also comprise the authorship of the media item, the royalty amount of each media item, the price per copy of the media item, whether the media item is available for combining, the business terms, rules, and rights governing the use of a media could include designations derived from the metadata such as whether a media item is designated non-commercial or commercial-only, or is designated as unavailable for inclusion in any derivative works or conversely is designated as available for inclusion in any derivative works, and designated as share-alike, meaning that a new derivative work containing the media portion can only be made available with identical licensing terms. In another embodiment, the metadata may be such as a universal resource locator (url) or pointer that directs the user to the media item which may be stored remotely from the registry.

In one embodiment, referring to FIG. 2, after the metadata is received 205, the media item registry compares 210 the metadata for its associated media item with the metadata that already exists for that media item in the media item registry. In one embodiment, if the metadata is new, i.e. there is no existing metadata for the particular media item, the media item registry will accept the submission. In one embodiment, if the new metadata duplicates the metadata already in the database for any other media item 215, the media item registry reports the duplication back to the submitting entity or user. In one embodiment, metadata may be considered duplicative if a particular combination of metadata elements are collectively duplicative with respect to the same elements for another media item. In another embodiment, the media item registry will only consider the metadata elements duplicative if the metadata elements are collectively duplicative with respect to the same elements for the same media item. Meaning, new metadata elements for the same media item will not be considered duplicative although some of the metadata elements already exists in that particular media item. Thus, allowing the metadata of a media item to be updated with new metadata.

In one embodiment, if duplicative metadata is found 215, the submitting entity or user may resubmit the metadata with changed information, abandon the submission, request service assistance, or some combination of these alternatives.

After the media item registry compares the metadata and determines that the data is not duplicative, the metadata is uploaded 220 to the media item registry. In one embodiment, metadata may be uploaded via sending the metadata alone, or the media item itself containing the metadata.

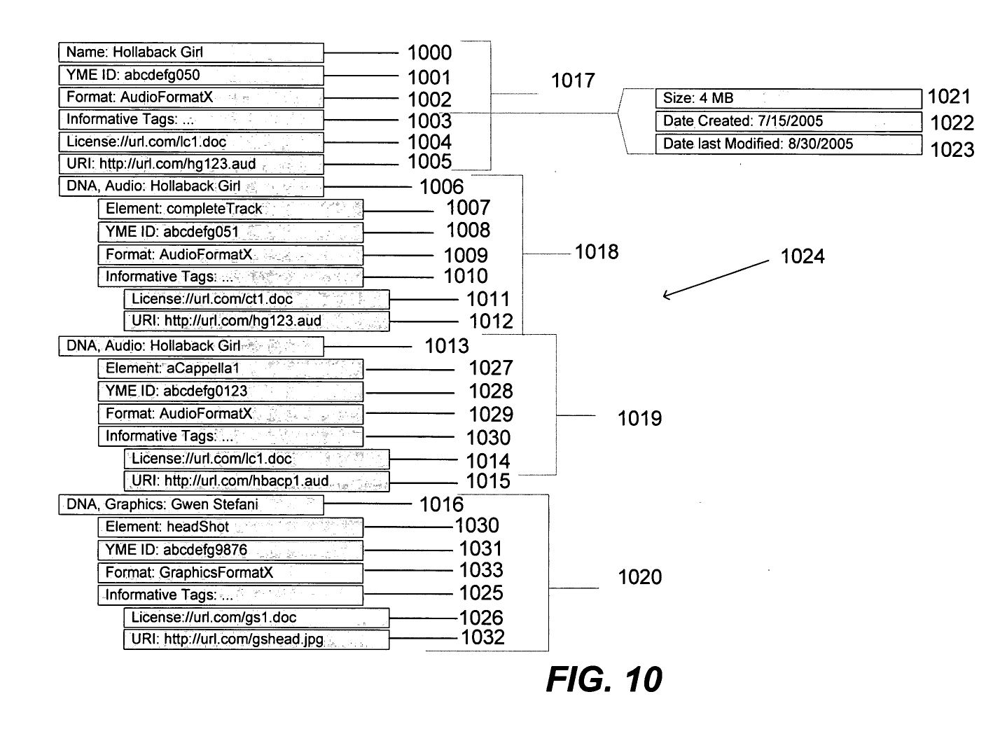

In another embodiment, metadata may be uploaded 220 by sending, copying, or uploading or any combinations thereof some or all portions of a data container structure associated with a media item. FIG. 10 illustrates one exemplary embodiment of a data container 1024 associated with a media item. As can be seen in the embodiment depicted in FIG. 10, the data container 1024 comprises of a first metadata subset 1018 associated with a media item portion, a second metadata subset 1019 associated with a media item portion, a third metadata subset 1020 associated with a media item portion, and container related metadata 1017. In the embodiment as depicted in FIG. 10, the first metadata subset 1018 is the complete media item or source media item, the second metadata subset 719 is a media item portion such as the A cappella vocals, that is, the same vocals as included in the complete media item, but without any instrumentals, and the third metadata subset 1020 is a graphical image such as a jpeg.

In one embodiment, the container related metadata 1017 can include any type, combination, or number of information or data associated with the attributes of the container itself. In another embodiment, the container related metadata can include any type, combination, or number of information or data associated with the attributes of a media item source, media item portion, or media item. In one exemplary embodiment, as depicted in FIG. 10, the container related metadata 1017 comprises a name or descriptive term associated with the container 1000, an internal metadata subset reference 1006, an ID unique to a community or online music service 1001, a format type of the container 1002, a set of informative tags 1003, a pointer to a set of rights. 1004, and a pointer 1005 to a physical file location of the associated media item. By analogy, it is contemplated that a container represents a genome for a media item, and the internal metadata is analogous to DNA that may be spliced to create new media “life forms”.

One exemplary embodiment of a metadata subset of a data container is depicted in FIG. 10. As discussed above, the metadata subsets are a subset or identifiable group that is derived from the metadata associated with a media item portion. For example, a metadata subset may comprise any number and combination of information or data about a media item portion such as the name of the artist or performer, the album name, the identity of a composer, the identity of lyricist, the identity of a lead performer or soloist, the date or time of recording of the media item, identity of the language associated with the media item, the original filename of the media item, the original release year of the media item, the format type of the media item, a URL or link to the official webpage of an on-demand music service or internet radio station, or the a URL or link to the official webpage of the artist, album, rights holder, or producer associated with the media item. As can be seen in FIG. 10, each of the metadata subsets 1018, 1019, 1020 comprise an internal metadata subset reference 1006, 1013, 1016; a name or descriptive term associated with the type of the subset 1007, 1027, 1030; an ID unique to a community or online music service 1008, 1028, 1031; a format type of the subset 1009,1029,1033; informative tags 1010, 1025, 1025; a pointer to a license 1011, 1014, 1026; and a pointer to a physical file location of the associated media item 1012,1015,1032.

In one embodiment, the container ID 1001, 1008, 1028, 1031 unique to a community or online music service may be associated with any type of entity capable of assigning unique IDs. In one embodiment, the unique id may correspond to the unique id assigned by the media item registry.

In one embodiment, the format type of the container 1002 describes the nature of the media items referenced in the data container. For example, the format may be audio, a podcast, enhanced podcast including visual material, MP3 or MC audio track, digital video, e-Book, or a webpage, blog or other format. Moreover, static media may also be included, such as a JPEG still image. In a further embodiment, the format type may be a logical combination or a concatenation of all the different types of format types included in the data container. In the present disclosure, the terms logic, logical, and rules are used interchangeably, and are generally intended to refer broadly to any application specific set of rules, instructions, or heuristics that may be implemented and followed to achieve a desired result. Accordingly, the format type of each of the metadata subsets 1009,1029,1033 may be audio, a podcast, enhanced podcast including visual material, MP3 or MC audio track, digital video, e-Book, blog entries, static media such as a JPEG still image, or other format.

In one embodiment, the informative tags 1003, 1010, 1025, 1025 can vary as to number or length. In the embodiment depicted in FIG. 10, the informative tags are associated with the container itself 1003. In another embodiment, the informative tags 1010, 1024, 1025 are associated with the metadata subsets 1018, 1019, 1020. An exemplary excerpt of the container related metadata informative tag 1003 is depicted in FIG. 10. As can be seen, the informative tag associated with the container related metadata 1003, includes the size 1021 of the container, the date the container is created 1022, and the date the container was last modified 1023. Other types of informative tags included in metadata subsets 1018, 1019, 1020 and/or the container related metadata 1003 includes, but is not limited to a string of text representing the name of the container, a string of text representing the media item portion title, pricing information, the genre associated with the overall items within the container, the length of the container, the content type of the container, the file type, the international standard recording code associated with the container, the software and/or hardware necessary for encoding and decoding the container and its items, and/or any user-defined text information.

In one embodiment, the pointer to a license 1004, 1011, 1014, 1026 includes, but is not limited to a pointer to licensing information or related message, a DRM authorization or message, contract terms, or copyright information or message. In one exemplary embodiment, a URL may reference a document containing machine-readable licensing information such as, for example, a machine readable Creative Commons license. In another embodiment, the license information might be directly embedded within the metadata subset and/or data container itself. Indirect reference of a licensing term or set of rights, in one aspect, enables the updating of terms as only the destination document need be changed to propagate new licensing terms to all relevant metadata subsets and/or data containers.

In one embodiment, the pointer to a physical file location of the associated media item 1005, 1012, 1015, 1032 comprises a pointer to a physical file location where a media item portion or media item may be found. In another embodiment, the media itself might be directly embedded within the metadata subset and/or data container. In one example, a URL may reference an MC audio media item portion stored on a server. Further, the media item or media item portion may be acquired from a server, the internet, or a user's local media library. Thus, in one aspect, through the indirect reference of the media item portion or media item, distribution and commerce is simplified, as data containers may be exchanged in a commerce implementation, without the inconvenience or expense of exchanging files in every transaction. Thus, the user in possession of a data container can cause the media to be streamed or transferred to his or her media player of choice when she desires to do so.

In one embodiment, a commerce enabling metadata subset associated with a media item portion is disclosed. In one exemplary embodiment, the commerce enabling metadata subset may comprise a set of commerce enabling information associated with a media item portion, wherein the portion is derived from a source media item and wherein the metadata subset is derived from a commerce-enabled related metadata associated with the source media item. As stated above, the media item portion and source media item can be of various types. Thus, the metadata subset remains associated with the media item portion in order to preserve a relationship between the commerce enabling information and the metadata portion when the source media item and the media item portion exists separately.

In one embodiment, the commerce enabling information comprises information that governs the use of a media item portion. For example, in one embodiment, such commerce enabling information comprises the identity of attribution, the identity of a rights holder, a link or address of a website, a copyright message or a pointer thereto, licensing information or pointer thereto, or a digital rights management (DRM) related message or pointer thereto. Furthermore, the commerce enabling information comprises the authorship of the media item portion, the royalty amount of each media item portion, the price per copy of the media item, whether the media item portion is available for combining with the media items, the business terms, rules, and rights governing the use of a media portion could include designations derived from the metadata subsets such as whether a media item portion is designated non-commercial or commercial-only, or is designated as unavailable for inclusion in any derivative works or conversely is designated as available for inclusion in any derivative works, and designated as share-alike, meaning that a new derivative work containing the media portion can only be made available with identical licensing term.

In a further embodiment, the commerce enabling metadata subset may be a part of a data container as discussed above.

Thus, in one embodiment, the metadata may be uploaded to the media item registry by extracting the data and/or duplicating all or portions of a media item's data container.

Referring back to FIG. 2, in one embodiment, once this metadata is uploaded 220, via the metadata, the registry is capable of recognizing use of the metadata and/or assessing the appropriate cost per use. In a further embodiment, the media item payment system is in communication with a media item registry and thus the media item media item payment system is capable of recognizing the use of the metadata associated with a registered media item via the metadata and/or unique ids and then can assess the appropriate cost and disburse payment. Further, the media item registry can share media item information and rights holder information with the media item payment so that the media item payment system can determine, collect, and/or disburse the appropriate payment due to the use/purchase of a particular media item.

As depicted in FIG. 2, after the metadata is uploaded 220 a unique media item id is generated 225. In one embodiment, the unique media item id comprises an alphanumeric string of characters. The media item id is associated with the media item. In one embodiment, the media item id is associated 230 with the media item by modifying the media item to incorporate the media item. For example, if the media item comprises a data container format as discussed herein, the data container may be modified to further include the media item id. In another embodiment, the media item id may be bound to the metadata of the media item. In another embodiment, the unique media item id may correlate to an id commonly used in the media item marketplace, thus recognizing use and identifying the media item is made easier. Of course, any combination of the above or other methods known to those skilled in the art for associating an id with a media item are contemplated.

In one embodiment, after a media item id is generated 225 and within the media item registry, the media item is not only associated with an id 225 but also with a rights holder id 230. In one embodiment, each media item may be identified with a combined id comprising a rights holder id and media item id so that both types of information are easily available and readily found by browsers, players, remix software tools, a media item payment system, or by commerce systems supporting remix or composite media item marketplaces. For example, a media item may be associated with an id such as “XX_ABC123” wherein XX represents the media item id and ABC123 represents the associated rights holder id.

Further, in one embodiment, when a media item is utilized whether purchased, used by a remix or composite media item software application, or generally transacted, a media item payment system handles the collection, and/or disbursement of revenues to the appropriate rights holder.

It should be noted that in one embodiment, the media item payment system can work independently from the media item registry. For example, the media item payment system can support the calculation of payments due multiple rights holders whose media portions make up part of a composite media item, such as a remix or “mash-up” regardless of whether the composite media item, it's media items, or its associated rights holder(s) are registered in the media item registry or regardless of whether they are associated with a rights holder id or media item id.

In an alternate embodiment, the media item payment system can work in conjunction with or be in communication with the media item registry. For example, when a media item portion or composite media item associated with a media item id is utilized, whether purchased, used by a remix or composite media item software application, or generally transacted, the media item registry can obtain the media item id and present any relevant data to the media item payment system so that the payment system can issue appropriate payment to the rights holder(s).

Regardless of whether the media item payment system works independently from the media item registry or in conjunction with the media item registry, the media item payment system works to handle the disbursement of revenues taken collected when a media item, whether a composite media item or media item portion, is sold or otherwise transacted in a network. Further, the media item payment system supports the calculation of payments due multiple rights holders whose media items portions make up part of a composite media item, such as a remix or “mash-up.” In one embodiment, the media item payment system does this by maintaining a rich, interconnected set of metadata that specifies the rights offered, rights holders, payment terms, and payee information for each media item, whether the item is a discrete, monolithic piece of media, or one that is composes of media portions from multiple rights holders.

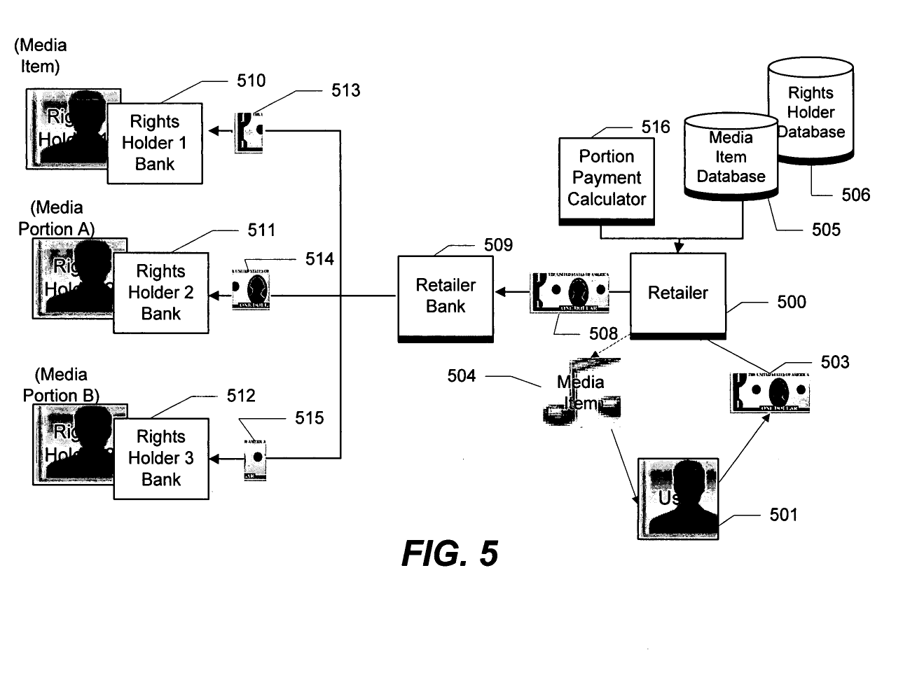

FIG. 5 depicts a system configuration or architecture supporting one embodiment of the media item payment system. As can be seen in FIG. 5, the system comprises of at least one user 501, a media item 504, a retailer 500, a portion payment calculator 516, a media item database 505, rights holder database 506, a retailer bank 509, and at least one rights holder banks 510, 511, and 512.

In one embodiment, a media Retailer 500 offers Media Items for sale and/or use. In one embodiment, these media items may include media items, media item portions and/or composite media items. In one embodiment, the media items may be viewed by a user online, found through a mobile Web interface, purchased through a short code system, or whatever retail setting and interface is appropriate to any of a limitless range of networked devices. For example, in one embodiment, a media retailer 500 may comprise a web-based online music store. In another, it may comprise a mobile content service that makes mobile content such as videos, ringtones, or other content available to mobile phones. In another, the retailer may embody a collection of content offered for sale via an application resident within a network-connected device, such as a PDA or portable game machine or media player.

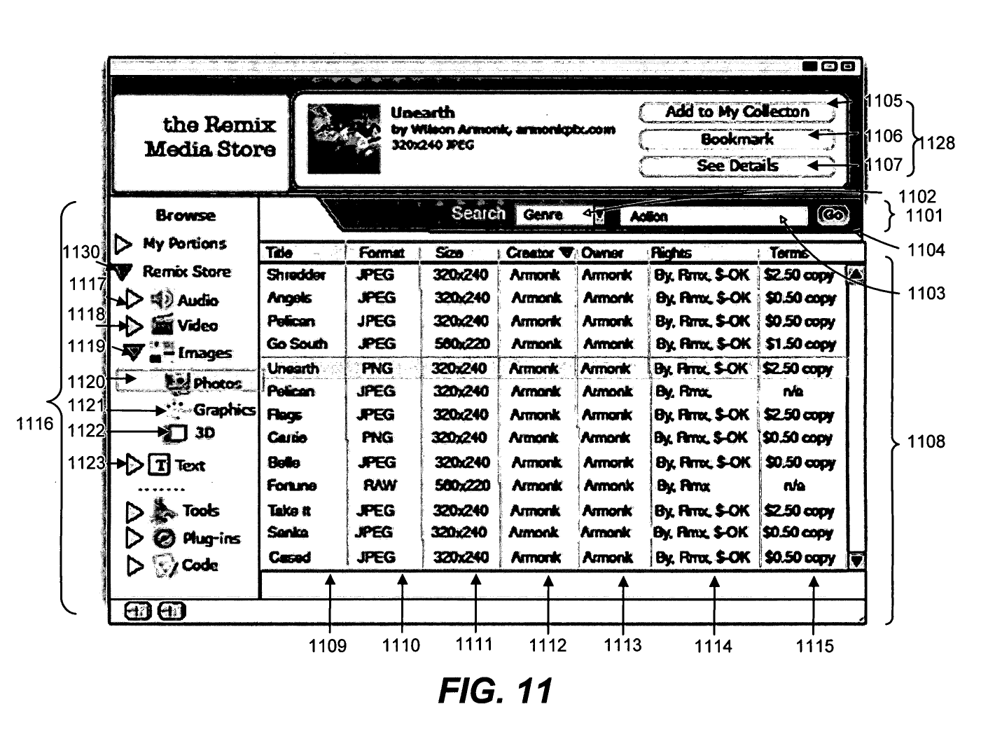

FIG. 11 illustrates one exemplary embodiment of a user interface of web-based media item retailer 500 that allows a user to search, browse, and/or purchase media items or media items portions. In one embodiment, the retailer 500 may be a database of media item entries. In one general embodiment, each entry is associated with a media item, relevant metadata, other associated information which may or may not be derived from the metadata associated with the media item, it's associated data container, and combinations thereof.

As can be seen in FIG. 11, in one embodiment, the user interface of the retailer 500 comprises several areas or regions 1128, 1101, 1108, and 1116. In one embodiment, the user interface comprises an area 1128 for viewing a thumbnail image or other graphical representation and/or summary information identifying a media item whether a composite media item or a media item portion and certain controls for manipulating or obtaining further information about the media item. As depicted in FIG. 11, area 1128 comprises several user input indicia, buttons, 1105, 1106, and 1107. In one embodiment, button 1105 adds the media item to a user's collection of media items. In one embodiment, adding a media item portion to a user's collection allows the media item portion to become available for further manipulation or editing as the user creates a new composite media item. In one embodiment, it is possible that the media item portion may be added to the collection without any charge, or that the media item portion carries a fee simply for acquiring it form possible future use, or there may be other commercial terms involved of different natures. In one embodiment, button 1106 adds a reference to the user's browser or to the user interface to a particular media item portion, such that the media item portion can be found and reviewed again at the user's convenience. In one embodiment, button 1107 enables the user to view and/or access further detail about a particular media item portion in an expanded view within the interface.

In one embodiment, the user interface further comprises an area 1101 for entering text representing a search or browse input criteria indicating a desired media item and a button 1104 for triggering the search of the retailer's 500 media items. In one embodiment, the area 1101 may comprise a text box 1103 and/or a drop down menu 1102. In one embodiment, the user may search the retailer 500 for media items by jointly using the text field box 1103 and the drop down menu 1102.

In one embodiment, with further reference to FIG. 11, the retailer's 500 user interface further comprises an area 1116 for browsing the retailer's 500 available media items. In one embodiment, a user may filter their browsing activity by selecting the kind or type of media the user is interested in. For example, as depicted in FIG. 11, the browsing area comprises categories such as audio 1117, video 1118, images 1119, and text 1124. In one embodiment, area 1116 allows a user to browse the subject media item portions via a categorical menu (1117-1123). For example, in one embodiment, selecting button 1130 allows a user to access and categorically browse the remix store i.e. retailer 500 or by categorical menu using area 1116.

In a further embodiment, the user interface further comprises an area 1108 for displaying the results of a media item search. In one embodiment, as depicted in FIG. 11, the area 1108 lists each media item entry, in this case media item portions, and/or metadata by columns associated with the media item portions. As seen in FIG. 11, each media item portion entry has an associated title column 1109 that lists the title of the media item portion, a format column 1110 for listing the type or format of the media item portion, a size column 1111 that lists the size of the media item portion, a creator column 1112 that identifies the creator of the media item portion, an owner column 1113 that identifies the owner of the media item portion, a rights column 1114 that identifies the rights associated with the media item portion, and a terms column 1115 that specifies terms, such as price, associated with the media item portion. Thus, the user is able to view the retailer's 500 information associated with each media item or media item portion through the user interface. Of course it is contemplated that the area 1108 for displaying the media item results may comprise some, all, none, or any other types of associated column categories, or any metadata associated with the media item.

In one embodiment, once a User 501 has selected a Media Item 504 he wants to purchase and/or use such as for use in a composite media item, he indicates the preference using any of a range of online/mobile commerce conventions, such as “add to shopping cart, and check out,” etc. In one embodiment, using any method discussed herein, when the User 501 purchases the Media Item 504, it is delivered through the network to the User's device. In one embodiment, the device may comprise any computing device such as a personal computer, personal digital assistant, media player, and/or a cellular telephone, or portable media player of any description.

After the User 501 has purchased and/or otherwise used the media item, payment 503 for the Media Item is transferred to the Retailer 500. In one embodiment, a credit card or other charge and payment flow is implemented, which typically involves a merchant acquiring bank, cardholder bank, and an indirect flow of User 501's payment into Retailer 500's Bank 509. Thus, in one embodiment, the User's Payment 503 ends up in Retailer 500's Bank 509 and the Media Item 504 is delivered to User 501's device.

In one embodiment, at the time of the transaction, or in one of a set of asynchronous batch processes executed periodically thereafter, the Portion Payment Calculator 516, capable of processing data, examines each transaction record. The portion payment calculator 516 obtains the database record (as discussed in greater detail herein) from the Media Item Database 505, in order to determine if the media item comprises other media item portions, the rights associated with each media item portion, the identity and remittance information of the associated Rights Holders, as stored in Rights Holder Database 506 are due payment and/or the amount of payment due. Thus, the portion payment calculator can calculate the payment due to the appropriate rights holder for purchase/use of the media item. Then, appropriate amounts are credited to the payable account of each Rights Holder, and the appropriate Portion Payment 513-515 of the original User Payment 503 is remitted to the appropriate Rights Holders or their Banks (510-512).

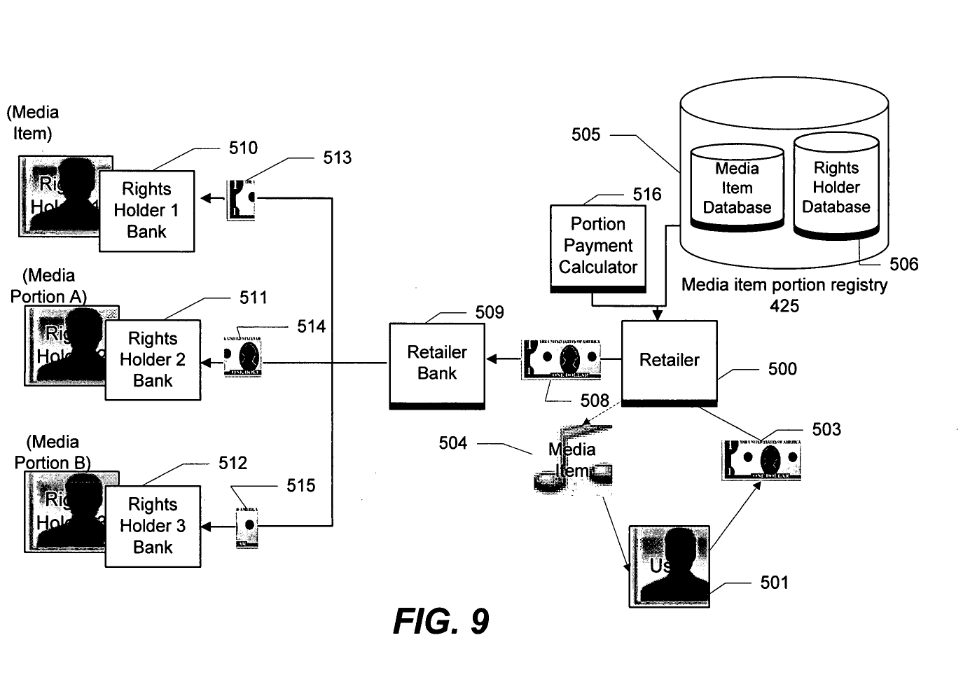

In one embodiment, the media item 504's metadata resides in Media Item Database 505. In one embodiment, as depicted in FIG. 9, the media item database 505 can be the same as or in communication with the media item registry 425 as depicted in FIG. 9. Further, although FIG. 9 depicts the media item database 505 and the rights holder database 506 as separate, in another embodiment, it is contemplated that these both are located in a single database, for example as the media item registry 425 as discussed herein.

Turning back to FIG. 5, In an alternate embodiment, the media item database 505 and the rights holder database 506 may be completely separate and different from the media item registry 425.

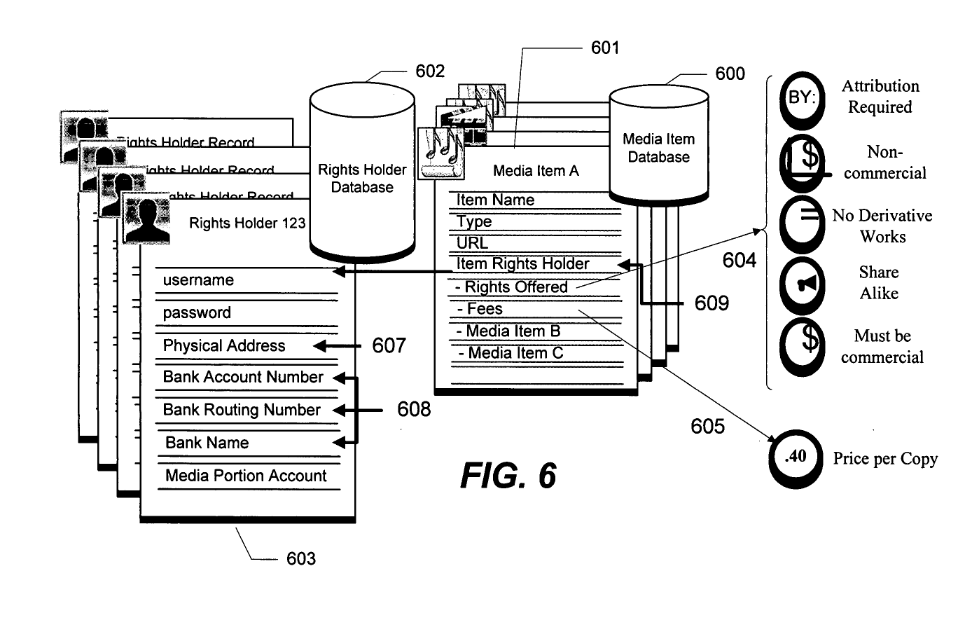

FIG. 6 illustrates an embodiment of the data stored in a media item database 600 and a rights holder database 602. As can be seen in FIG. 6, a media item database 600, contains Media Item Records such as 601. In one embodiment, there is one Media Item Record per Media Item in the Retailer's inventory. In one embodiment, the Media Item Record 601 contains at a minimum descriptive information, such as Item Name, Media Type, the URL where the item file is stored, and also relevant commerce enabling information, such as the Rights Holder 603 of the Item, the Rights Offered 604 for purchase, and Fees 605 associated with sale of the Item. Rights 604 specify the uses the Media Item may be put to, the way in which copies or derivative works incorporating the Media Item may be undertaken, and so on. Such rights would be similar to those of Creative Commons (http://www.creativecommons.org) but would include additional rights declarations enabling commerce at a system level, such as the designation that the distribution of a Media Item Must be Commercial (compensation required). In one embodiment, the Price per Copy of the Media Item 601 is set by the Rights Holder 603. This is the amount Rights Holder 603 expects to receive when his/her Media Item is sold or licensed.

Additionally, optional information specifies other Media Items which may be incorporated as Media Item Portions 606 within the Media Item Record 601. While Media Items used to create other Media Items may be usefully referred to as “Media Item Portions,” from a data structure standpoint they are the same as Media Items.

In one embodiment, the information found in a media item record 601 is copied and/or extracted from the media item's data container information as discussed above. Thus, the media item data container information may be used to create and/or fill in a portion or all of a media item record 601,

In another embodiment, the media item record 601 may take the form of a data container as described in FIG. 10.

In one embodiment, if Media Item contains Media Item Portions 606, the media item portion information is found in the Item's data. That is, filled (or non-empty) Portion fields indicate media item portions are present. There are other ways to indicate that media item portions are present as well, such as maintaining a boolean “flag” indicating presence of media item portions. In any event, media item portions indicated in a Media Item Record may comprise Media Item IDs referring to Media Items also found in the Media Item Database 600.

Further, in one embodiment, the Rights Holder field 609 in the Media Item Record 601 contains an ID or pointer into a Rights Holder Database 602, where a full set relevant information can be found in the corresponding Rights Holder Record 603. In one embodiment, the Rights Holder Record 603 contains such information as username, and password, and may contain a pointer to an account record where payments due the Rights Holder are aggregated or otherwise recorded. In one embodiment, as depicted in, the Record 603 also contains payee information for FIG. 6 the Rights Holder 123, such as a Physical Address 607 where a paper check may be sent, or Bank Information 608 enabling a direct transfer of funds such as through an ACH transaction.

Additionally, in one embodiment, the information found in a rights holder record 603 is copied and/or extracted from the media item's data container information as discussed above. Thus, the media item data container information may be used to create and/or fill in a portion or all of a rights holder record 603,

In another embodiment, the rights holder record 603 may take the form of a data container as described in FIG. 10.

In one embodiment, where the media item database 600 and/or rights holder database 602 is the same as or in communication with the media item registry, the media item registry supplies the media item payment system with similar information associated with a media item which was uploaded by the rights holder. For example, such metadata may comprise media type, artist, title of the media item, length, or any type of commerce enabling information. In another embodiment, the metadata may be such as a url or pointer that directs the user to the media item which may be stored remotely from the registry. Further, the information may comprise information associated with the rights holder such as the rights holder account information and remittance information as discussed herein. In one embodiment, this information is used to create and/or fill in information in the rights holder record 603 and/or media item record 601.

Further, in one embodiment, the media item payment system is capable of disbursing the appropriate payment to multiple rights holders in a scenario having multiple media item portions and nested media item portions wherein each of these Items as Portions has associated Rights, Fees/Terms, and Rights Holder information.

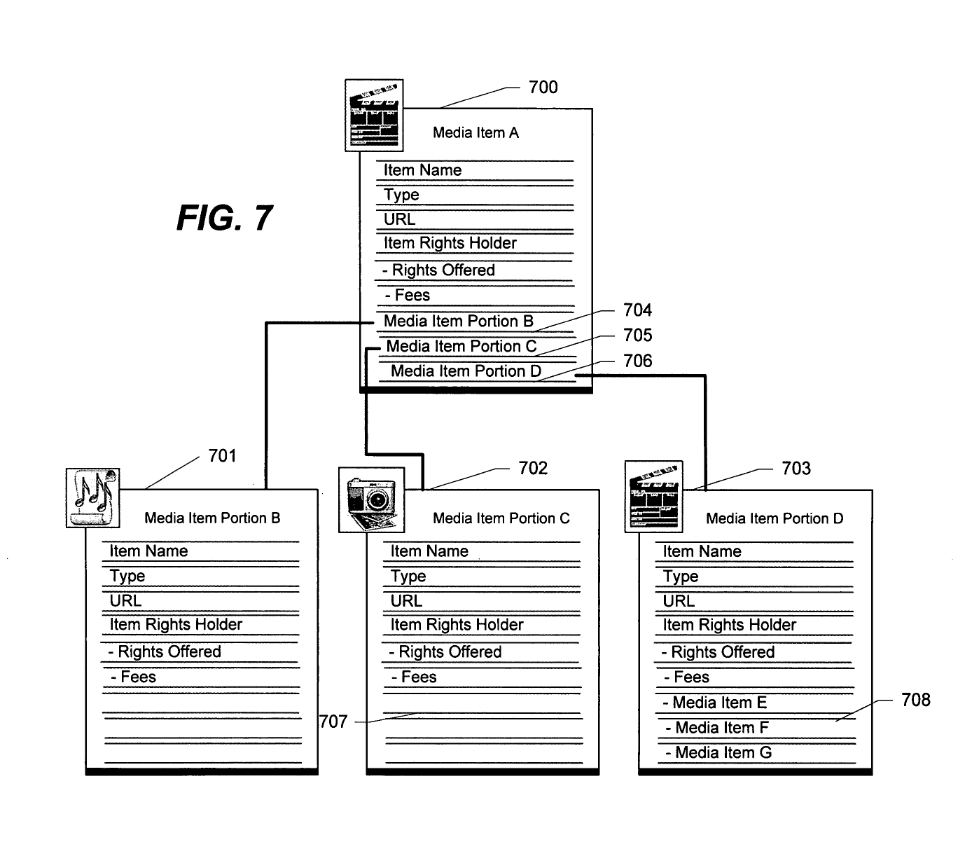

FIG. 7 more fully describes a relationship between a Media Item and Media Portions. As depicted in FIG. 7, a Media Item 700 is comprised of a set of data that sets forth information necessary to enable commerce in such items. In some embodiments, Media Items are discrete entities—a monolithic media product with no sub-elements. In another embodiment, Media Items may optionally “contain” other Media Items. In other words, two or more pieces of media that might otherwise be consumed separately have been used in creating a third Media Item.

In one embodiment, while Media Items used to create other Media Items such as composite media items may be usefully referred to as “Media Item Portions,” from a data structure standpoint they are just Media Items. If Media Item contains Media Portions, the media item portion information is found or referenced in the Item's data. That is, non-empty Portion fields indicate Portions are present.

In FIG. 7, Media Item A 700 incorporates Media Item Portions as indicated by references B 704, C 705, and D 706, referring to Media Items 701, 702, and 703 respectively. Thus, in Media Item A 700 can be considered a composite media item as it comprises of two or more media item portions which can be composite media items in themselves. For example, Media Item A may be a video work, and includes music 701, a still image 702, and another video clip 703. Note that these Media Item Portions may themselves include additional Portions; Item 702 does not (as evidenced by empty fields 707, and item 703 does include portions, as indicated by populated fields 708.

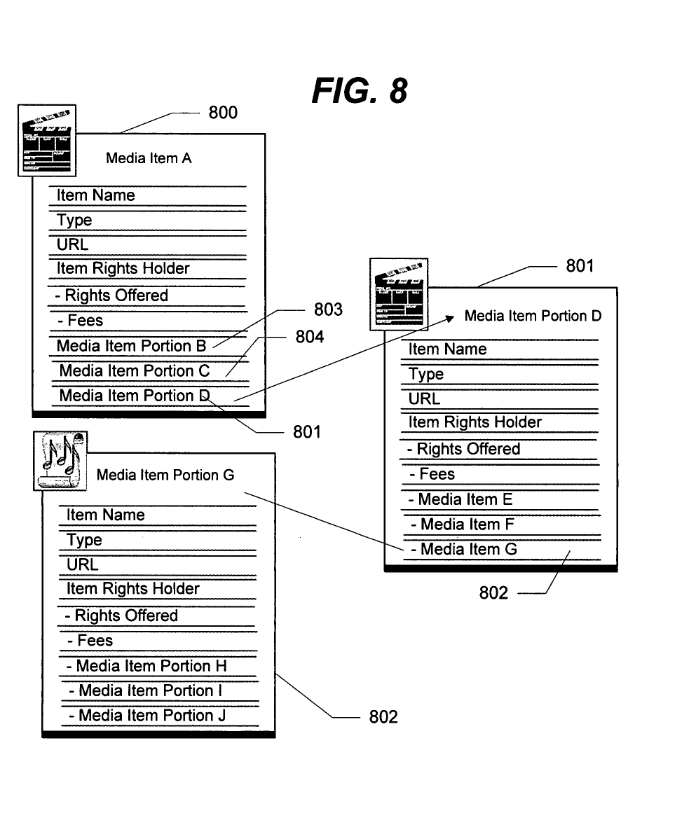

In a further embodiment, the media item payment system is capable of capturing the data necessary from nested media items (media items containing media items) to for calculating payments when a composite media item and/or media item portion is purchased and/or used. FIG. 8 depicts an exemplary embodiment of how such nesting of Media Items as portions can be accomplished, and indicates the need for a recursive processing by the media item payment system of any Media Item in order to fully capture relevant Payee information. As can be seen in FIG. 8, composite Media Item A 800 comprises several Media Item portions, Media Item Portion B 803, C 804, and D 801. This Media Item D is also a composite media item as it 801 further comprises Media Item G 802 among its media item portions. Media Item G 802 may in turn include still more media item portions. Each of these Media Items as Portions has associated Rights, Fees/Terms, and Rights Holder information associated with it, and the Portion Payment Calculator 516 is capable of gathering the information to appropriately disburse funds. If a Media Item Portion itself contains Portions, each is recursively (meaning, a process identical to the currently running process is spawned within the operation of the running process—i.e., a function calls itself) examined until a full set of all Rights Holders to be paid is created in a separate data structure used as a “payment list.” Subsequently, the Portion Payment Calculator 516 walks through the payment list and, for example, generate automated clearing house, bank to bank, payment instructions to be pushed to Retailer's Bank, or more simply adds the amount due to each Rights Holder's payable balance. Periodically, or when a given value threshold is attained, each Rights Holder receives its payment.

In principle, two or more media item portions can contain the same third portion. In this case, the media item payments system may calculate a single, or multiple amount payable, according to policy.

Note, that the end-user price for a Media Item containing other, nested Media Items should be sufficient to cover the fees for all the component parts. This can checked at the point of creation in a “remix” application that puts the media together, or when a Media Item is ingested into the Retail system.

Thus, the media item payment system of the present disclosure is capable of delivering the unique payments capabilities required by a media marketplace where products are composed of components from multiple rights holders. Further, the media item payment system in conjunction with or independent of the media item registry, provides the necessary functionality to enable both independent or user generated content, while providing necessary rights, payment, and accounting functionality to enable traditional media companies, such a record labels or studios, to make content available for remix use on a compensated, fully credited basis.

The present disclosure also addresses the need for a system or registry which prevent the fraudulent association of rights holders with media items that the rights holder does not own or is not associated with. Further, it is important to prevent payment of use of the media item to the incorrect rights holder. For example, Rights holder A may make a media item available on the registry that is associated with his rights holder id. Rights holder B modifies Rights holder B's media item to substitute his own rights holder id. Thereafter, payment that would have been incorrectly directed to Rights holder A is directed instead to Rights holder B. Accordingly, the present disclosure relates to a system and a method for reporting discrepancies among media items, rights holder and their associated ids. In a further embodiment, the present disclosure provides a method for handling such discrepancies as described in further detail herein.

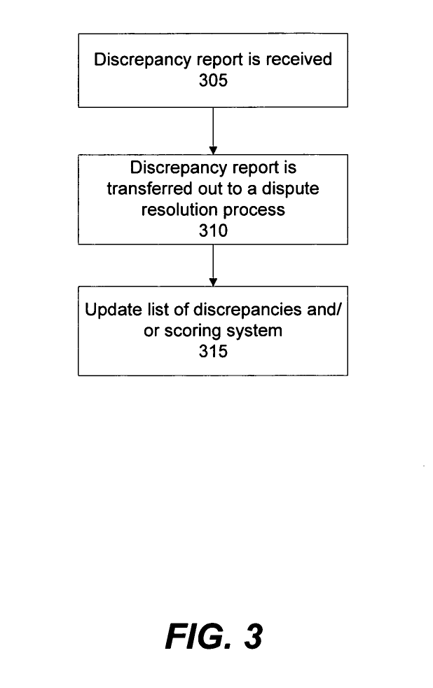

One exemplary method of handling a discrepancy among media items, rights holder and their associated ids is depicted in FIG. 3. In one embodiment, a discrepancy may comprise an incorrect association among a media item, a media item id, a rights holder, account information, remittance information, usage rights information, a rights holder id, media item metadata, or any combination thereof. For example, a user may in a remix or composite media item software application utilize a “Hollaback Girl” a cappella audio media item portion, but the remix application displays, via information returned by the media item registry, information indicating the track is entitled “Not What You Think” by the artist “Fraudster”, thus a discrepancy has been identified. This discrepancy is problematic because a media item portion is fraudulently associated with an incorrect media item portion title and an incorrect rights holder. In another example, a discrepancy could comprise the incorrect usage being associated with a media item portion. Using the example above, “Hollaback Girl” could be incorrectly associated with a no payment upon usage designation, when in fact, “Hollaback Girl” is has a specific cost associated with the use of the media item portion. Thus, the discrepancy prevents the associated rights holder from receiving accurate payment from the use of the “Hollaback Girl” media item portion, In another embodiment, an automated software application may sweep various online sources to compare and determine potential discrepancies.

As can be seen in FIG. 3, a discrepancy report is received 305 at the media item registry. In one embodiment, the discrepancy report is sent by a reporting entity such as a user. In one embodiment, the report may be submitted to the media item registry through an input element of a web-based user interface. The web-based user interface may or may not be a part of the media item registry user interface. For example, the web-based user interface may be a part of a general discrepancy reporting online service which in turn, sends the report to the media item registry.

When the discrepancy report is received 305, the media item registry transfers or sends 310 the report to a dispute resolution process. In one embodiment, the dispute resolution process is conducted by an entity external to the media item registry. In one embodiment, the dispute resolution process may comprise any of the following actions or combinations thereof: notifying the conflicting rights holder of the discrepancy, freezing accounts of the likely offender, freezing both parties' accounts, or freezing funds payable to one or both of the parties, and/or terminating the accounts of one or both of the parties. In a further embodiment, where the media item registry and media item payment are in the same or in communication with each other, the media item registry may notify the media item payment system so that no further payments are disbursed until the discrepancy is resolved.

In a further embodiment, the media item registry may maintain 315 a listing of discrepancies associated with a particular rights holder, or a reliability score that decreases as mistakes or discrepancies are identified, enabling the media item registry to in effect display a reputation rating to parties who might be interested in making purchases from or otherwise doing business with the particular Rights holder.

Thus, the media item registry allows an entity to register rights holders, their associated media items, and handle discrepancies among media items, rights holder and their associated ids in order to ensure accurate associations and payment. Further, the media item registry can determine who to pay when a transaction involving a certain media item occurs.

Those skilled in the art will recognize that the method and system of the present disclosure within the application may be implemented in many manners and as such is not to be limited by the foregoing exemplary embodiments and examples. In other words, functional elements being performed by a single or multiple components, in various combinations of hardware and software, and individual functions can be distributed among software applications at either the client or server level. In this regard, any number of the features of the different embodiments described herein may be combined into one single embodiment and alternate embodiments having fewer than or more than all of the features herein described are possible. Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known and features of those variations and modifications through the system component described herein as would be understood by those skilled in the art.

I claim:

1. A method of registering a rights holder in a media item registry comprising:
receiving, at an online media item registry, account information associated with a rights holder, said rights holder associated with rights in a media item, said media item being available to create a composite media item; and
generating a unique id associated with said rights holder, said id being associated with said media item so that as said media item is used in commerce said unique id remains linked to said media item to thereby enable said media item to be utilized in accordance with requirements established by said rights holder.

2. The method of claim 1 wherein said media item comprises a media item portion.

3. The method of claim 1 wherein said media item comprises a data container format.

4. The method of claim 3 wherein associating said unique id with said media item comprises incorporating said unique id into said data container format.

5. The method of claim 1 wherein said account information comprises an identity of said rights holder.

6. The method of claim 1 wherein said account information comprises an address associated with said rights holder.

7. The method of claim 1 wherein said account information comprises contact information associated with said rights holder.

8. The method of claim 1 wherein said account information comprises a user-defined login.

9. The method of claim 1 wherein said account information comprises a user-defined password.

10. The method of claim 1 further comprising receiving remittance information associated with said rights holder.

11. The method of claim 10 wherein said remittance information comprises bank account information associated with said rights holder.

12. The method of claim 10 wherein said remittance information facilitates a payment to said registry, said payment comprising a fee associated with maintaining said registry.

13. The method of claim 10 wherein said remittance information facilitates a payment to said rights holder, said payment comprising a fee associated with use of said media item.

14. The method of claim 1 wherein said id comprises an alphanumeric string of characters.

15. The method of claim 1 wherein said incorporated id is searchable on the internet.

16. The method of claim 1 wherein said rights holder is an entity.

17. The method of claim 1 wherein said id is required in order to use said media item in a derivative work.

18. The method of claim 1 further comprising authenticating said rights holder id..

19. A method of registering a media item with an online media item registry comprising:
receiving, at an online media item registry, a set of metadata associated with a media item, said media item being available to create a composite media item;
generating a media item id associated with said media item and said set of metadata, said media item id being associated with said media item; and
storing at least said generated id so that said media item and said set of metadata are available to a searching entity.

20. The method of claim 19 wherein said media item comprises a media item portion.

21. The method of claim 19 wherein said media item comprises a data container format.

22. The method of claim 21 wherein associating said media item id with said media item comprises incorporating said media item id into said data container format.

23. The method of claim 19 wherein said media item id is associated with a first rights holder id associated with a first rights holder, said first rights holder associated with said media item.

24. The method of claim 24 wherein said first rights holder id must be authenticated before said first rights holder id can be associated with said media item id.

25. The method of claim 24 further comprising replacing said first rights holder id with a second rights holder id associated with a second rights holder if ownership of said media item is transferred from said first rights holder to said second rights holder.

26. The method of claim 19 further comprising sending, if said media item id is requested, said metadata set to a requesting entity.

27. The method of claim 26 wherein said requesting entity must be authenticated before said metadata set can be sent to said requesting entity.

28. The method of claim 19 further comprising sending, if said media item id is requested, said media item to a requesting entity.

29. The method of claim 27 wherein said requesting entity must be authenticated before said media item can be sent to said requesting entity.

30. The method of claim 19 wherein said metadata set comprises commerce enabling information associated with said media item.

31. The method of claim 19 wherein said metadata set comprises a pointer associated with said media item.

32. The method of claim 19 wherein said metadata set comprises an uniform resource locator associated with said media item.

33. The method of claim 19 wherein said metadata set comprises a title associated with said media item.

34. The method of claim 19 wherein said metadata set comprises an artist name associated with said media item.

35. The method of claim 19 wherein said metadata set comprises an identity of a creator associated with said media item.

36. The method of claim 19 wherein said metadata set comprises content of said media item.

37. The method of claim 19 wherein said metadata set comprises a length of said media item.

38. The method of claim 19 wherein said media item id comprises an alphanumeric string of characters.

39. The method of claim 19 wherein said media item id is searchable on the internet.

40. The method of claim 19 wherein said set of metadata is not stored in said media item registry if said set of metadata is already associated with a media item id.

41. A method of reporting discrepancies associated with a media item comprising:
receiving, at an online media item registry, a user-defined discrepancy report, said report comprising information associated with a discrepancy associated with a media item, said media item associated with a media item id;
transferring said discrepancy report to a dispute resolution process; and
notifying a rights holder associated with said media item.

42. The method of claim 41 wherein said media item comprises a media item portion.

43. The method of claim 41 wherein said discrepancy comprises an incorrect rights holder associated with said media item.

44. The method of claim 41 wherein said discrepancy comprises an incorrect set of metadata associated with said media item.

45. The method of claim 41 further comprising notifying said incorrect rights holder of said discrepancy.

46. The method of claim 41 wherein a payment associated with use of said media item is suspended upon receipt of said discrepancy.

47. The method of claim 41 further comprising removing said media item from said registry until said discrepancy is resolved.

48. A method of registering a rights holder in a media item registry comprising:
receiving, at an online media item registry, account information associated with a rights holder, said rights holder associated with rights in a media item, said media item being available to create a composite media item; and
generating a unique id associated with said rights holder, said id being associated with said media item so that as said media item is used in commerce said unique id remains linked to said media item to thereby enable said rights holder to be appropriately compensated for said use of said media item.

49. The method of claim 48 wherein said media item comprises a media item portion.

50. The method of claim 48 wherein said use comprises combining said media item with another media item so as to create a composite media item.

51. The method of claim 48 wherein said use comprises a purchase of said media item.

52. The method of claim 48 wherein said media item comprises a data container format.

53. The method of claim 48 wherein associating said unique id with said media item comprises incorporating said unique id into said data container format.

54. The method of claim 48 wherein said account information comprises an identity of said rights holder.

55. The method of claim 48 further comprising receiving remittance information associated with said rights holder.

56. The method of claim 55 wherein said remittance information comprises bank account information associated with said rights holder.

57. The method of claim 55 wherein said remittance information facilitates a payment to said rights holder, said payment comprising a fee associated with said use of said media item.
